(19) United States
(12) Patent Application Publication
(10) Pub. No.: US 2016/0132847 A1
(43) Pub. Date: May 12, 2016

(54) System, method, and computer program for conducting online banking using a computer, a mobile communication device, or a wearable mobile communication device and a human teller

(71) Applicant: William Sarris, Pebble Beach, CA (US)

(72) Inventor: William Sarris, Pebble Beach, CA (US)

(21) Appl. No.: 14/121,970

(22) Filed: Nov. 8, 2014

(51) Int. Cl. G06Q 20/10; H04N 7/14; G06Q 30/00

(52) U.S. Cl. CPC G06Q 20/108; G06Q 30/016; H04N 7/141

(57) ABSTRACT

The present invention relates to an online banking application for a computer or a mobile communication device that incorporates a human teller in the banking transaction using audio, video, and text communication between the customer and the banker.

### RELATED APPLICATION

The present application is a continuation-in-part of U.S. patent application Ser. No. 14/120,226 filed May 7, 2014 for a System, Method, and Computer Program for Conducting Online Banking Using a Computer or a Mobile Communication Device and a human teller.

### FEDERALLY SPONSORED RESEARCH

Not Applicable

### SEQUENCE LISTING OR PROGRAM

Not Applicable

### BACKGROUND

1. Field of Invention

The present invention relates generally to the field of digital banking on computers, mobile communications devices, and wearable mobile communication devices. More specifically, the present invention relates to an online banking application for a computer, a mobile communication device, and/or a wearable mobile communication device that incorporates a human teller in the banking transaction using audio and video communication between the customer and the banker.

2. Description of the Prior Art

Traditional banking methods entailed making a trip to a banking facility and conducting banking transactions in person with another human being, generally a teller or loan officer employed by the user's financial institution. For the sake of convenience to the individual user, financial institutions developed a remote banking kiosk (the automated teller machines—or “ATM”) that permitted its customers to make a limited number of financial transactions (generally withdrawals and deposits) at remote locations and at any time of the day. The convenience afforded by the ATM was greatly expanded with the introduction of the Internet, which permitted bank customers to perform an increased number of banking transactions using an Internet interface with the financial institution. The increased popularity of mobile communication devices such as mobile telephones, tablet computers, and the like allowed these customers to perform these transactions in locations other than their home or office. Accordingly, the prior art contains numerous examples of devices that permit individuals to conduct routine financial transactions without having to physically visit a financial institution or involve another human being in the process.

By way of example, U.S. Pat. No. 8,626,658 issued to Kapulkin et al. (2014) discloses methods, systems, and an apparatus for providing a dynamic account list in an online financial services system. While the methods, systems, and apparatus disclosed by Kapulkin and so many others found in the prior art represented a valuable enhancement to personal online financial management personal services and financial services websites, there are systems, methods, and computer programs that can improve on them as well. The present invention embodies such improvements to the methods, systems, and apparatus disclosed by Kapulkin and so many others found in the prior art.

Large financial institutions are able to offer a wide array of online banking services at a relatively low cost, which forces smaller (generally local or regional) banks to offer the same services in order to remain competitive. However, switching to online banking also forces these smaller banks to give up one of the major advantages they have typically maintained over larger banks: their employees' familiarity with their customers and their employees' personalized customer service. Put simply, the smaller community banks have had to risk losing the physical interaction advantage they once had over larger banks.

Large financial institutions have traditionally offered the advantage of banking services through a large number of branch facilities in many diverse locations. However, because customers were making financial transactions in remote locations away from home, they became less and less familiar with the banks' representatives such as the tellers or loan officers. Accordingly, the services these large banks provided customers became more and more impersonal with respect to individual customers. For time-conscious customers, convenience would typically be a higher priority than familiarity with the bank's representatives. When these large banks began offering the added convenience of online banking, these time-conscious customers had already been introduced to banking with unfamiliar personnel. As such, the removal of a human bank representative from the financial transaction was not a major detractor and banking industry studies indicate that a majority of the banks' customers regularly utilize online banking services.

While many customers appreciated the convenience offered by banking in a convenient location such as a branch near their office or shopping area or more recently, banking online, there are many transactions that require the involvement of a bank representative. Further, while many customers are not bothered by the impersonal nature of online banking, there are also many customers who prefer to work with a responsive person instead of a machine. While the devices described in the prior art for automated and/or online banking are long on convenience, they all lack a key ingredient in maintaining loyalty to a particular financial institution: contact with another human being that can demonstrate genuine interest in the individual using the services of the financial institution. While it is arguably easier to conduct financial transactions from the comfort of one's home or office or other convenient location, the relationship between the user and the financial institution is one of pure convenience. Put another way, there is little, if any, customer loyalty to the financial institution. The process of developing a relationship with one's banker has been replaced by the convenience of not having to physically visit the financial institution at all. Financial institutions are sensitive to this erosion of customer loyalty and have signaled a need for some way of humanizing online financial transactions.

### SUMMARY

### Objects and Advantages

The present invention has been designed to address the foregoing problems found in the prior art. Specifically the present invention addresses this need to instill and maintain customer loyalty by introducing a real-time video image of an actual, on-duty, representative of the financial institution into the financial transaction. Using the present invention, the user can, if he/she desires, virtually “wait in line” at a bank and engage the services of a live teller or bank officer while banking online from a remote location. Accordingly, the objects and advantages of the present invention are to:
(1) Provide an online banking system and method that solves the problems found in the prior art.
(2) Provide an online banking system and method that entails the use of a customer's personal computer and a live video screen image of a representative of the financial institution.
(3) Provide an online banking system and method that entails the use of a customer's mobile communications device and a live video screen image of a representative of the financial institution.
(4) Provide an online banking system and method that entails the use of a customer's wearable mobile communications device (such as a Smart Watch®, Google Glass®, and the like) and a live video screen image of a representative of the financial institution.
(5) Provide an online banking system and method that enables direct video, audio, and text communications between bank employees and customers so that bank employees can assist customers with banking transactions as if those customers were physically in the bank itself.
(6) Provide an online banking system and method that places the online customer in an electronic virtual queue with other online banking customers to wait for an available online banking representative to provide assistance.
(7) Provide an online banking system and method that provides the banking representative, teller or loan officer with immediate personal information about the customer in the queue to enable a personal salutation to that customer.
(8) Provide an online banking system and method that provides the banking representative with transactional information about the customer such as account information to enable facilitation of online assistance with executing banking transactions.
(9) Provide an online banking system and method that enables banking representatives to see other representatives of the bank who are online at the same time.
(10) Provide an online banking system and method that enables banking representatives to transfer customers in the queue to other bank representatives who are also on line at the same time for further assistance or faster service.
(11) Provide an online banking system and method that enables banking representatives to transfer customers in the queue to other bank representatives who can assist customers with banking issues outside the purview of the bank representative currently assisting that customer.
(12) Provide an online banking system and method that is more secure than traditional online banking methods.
(13) Provide an online banking system and method that permits tellers to take calls from online bankers in a virtual queue when not assisting customers who are physically present at the bank thereby greatly reducing bank employee downtime.
(14) Provide an online banking system and method that permits tellers who are not assisting customers who are physically present at the bank to verbally communicate directly with customers utilizing wearable mobile communications devices thereby greatly reducing bank employee downtime.
(15) Provide an online banking system and method that permits tellers from all branches of a financial institution to assist online customers from a virtual queue thereby creating shorter wait times for those customers in the virtual queue.
(16) Provide an online banking system and method that permits a banker to access customers' accounts in a similar manner to how they would access those accounts when the customers are physically visiting the branch.
(17) Provide an online banking system and method that uses digital data exchanges and live video stream feeds to establish two-way audio, video, and text communication between a banker and a customer conducting an online financial or banking transaction.

Additional objects, advantages, and novel features of the present invention will be set forth in the description, drawings, and claims which follow and will become apparent to those skilled in the art upon examination of said specification, drawings, and claims. Further, additional objects, advantages, and novel features of the present invention may also be learned through the practice of the present invention.

### DRAWINGS

### Drawing Figures

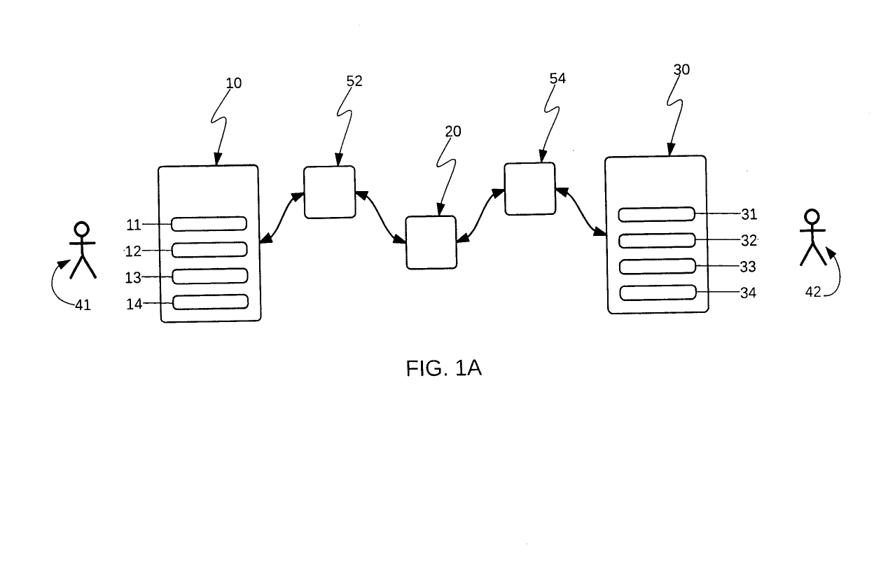

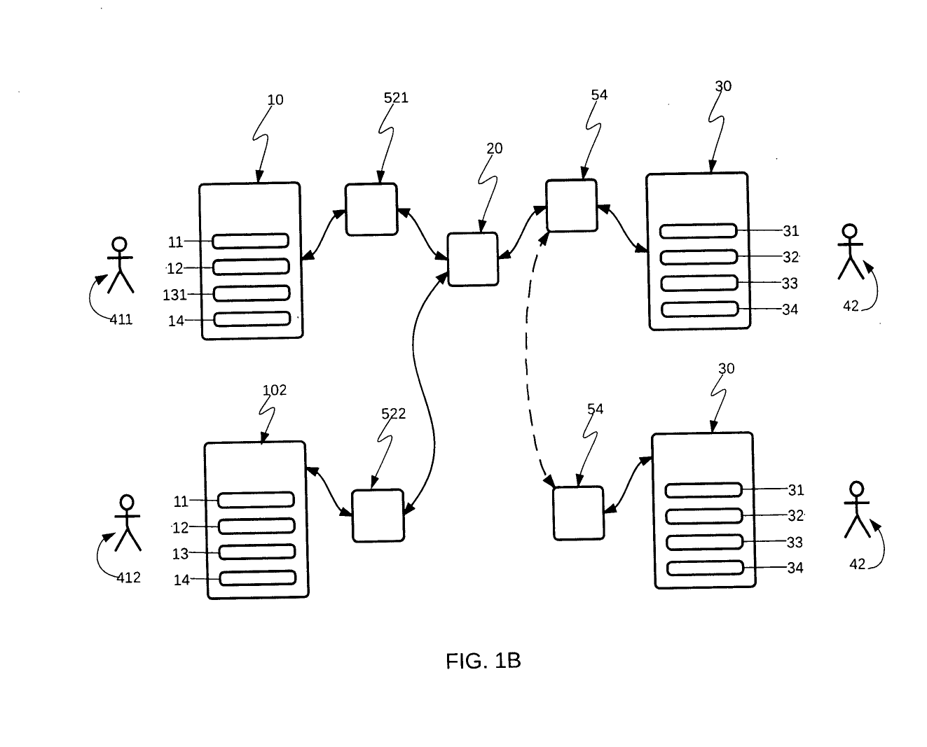

FIG. 1A is a basic flow diagram of the present invention showing the interaction of major participants in an online banking transaction.

FIG. 1B is a basic flow diagram of the present invention showing the interaction of multiple major participants in an online banking transaction.

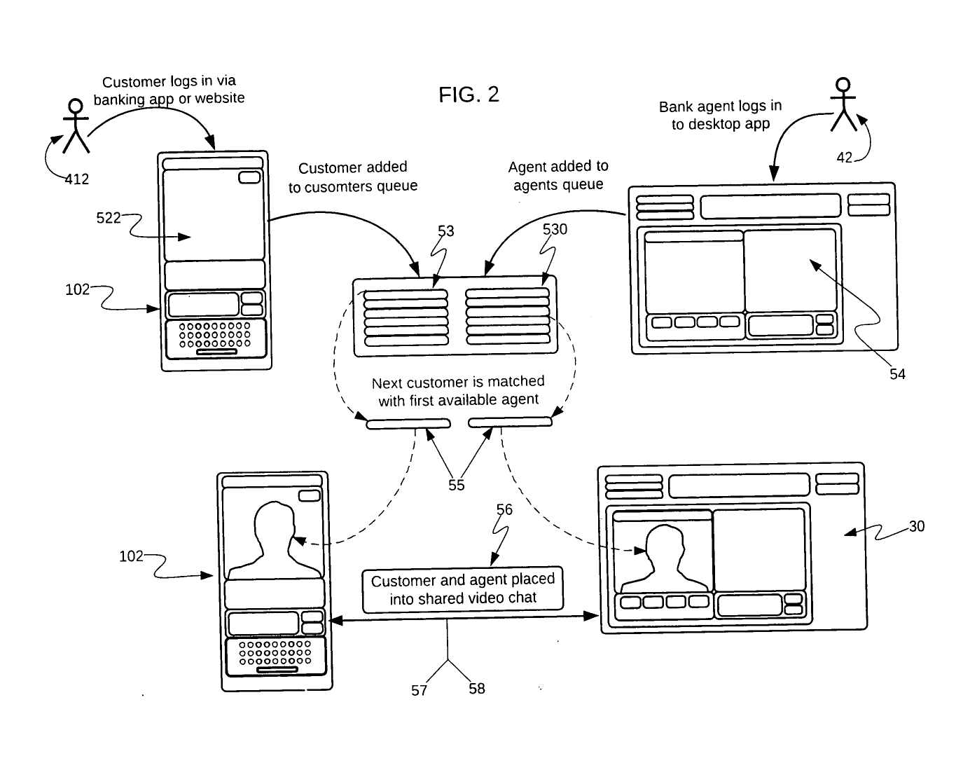

FIG. 2 is a basic flow diagram of the present invention showing the interaction between a generic customer using a computer or mobile communication device and a bank representative.

FIG. 2A is a basic flow diagram of the present invention showing the interaction between a generic customer using a wearable mobile communication device and a bank representative.

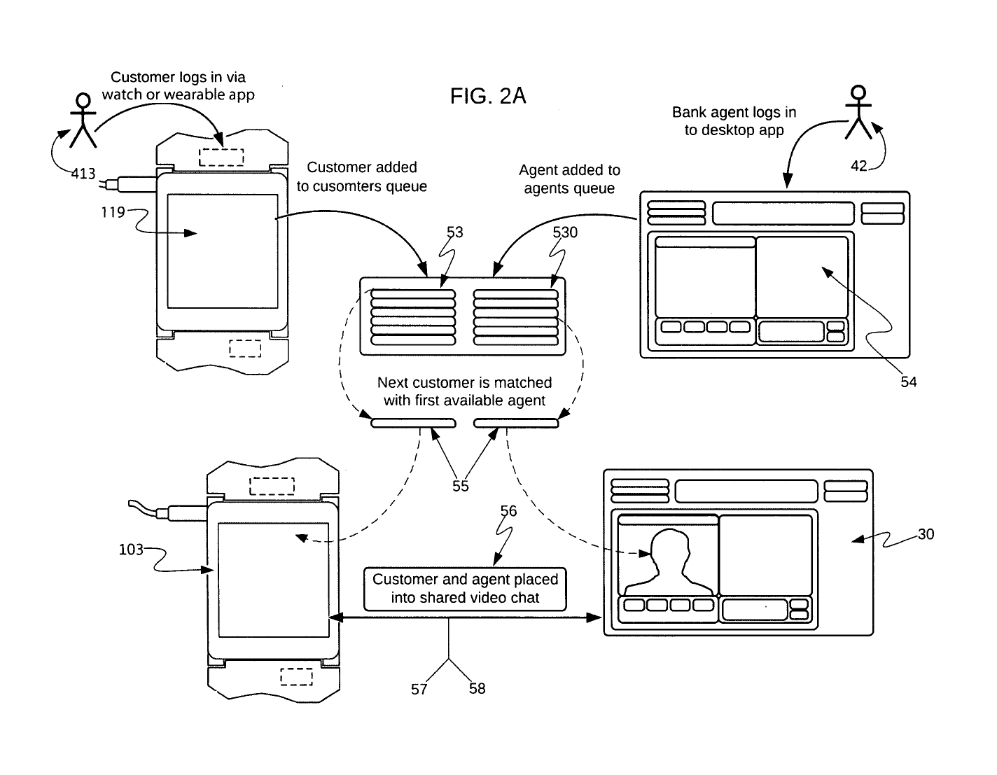

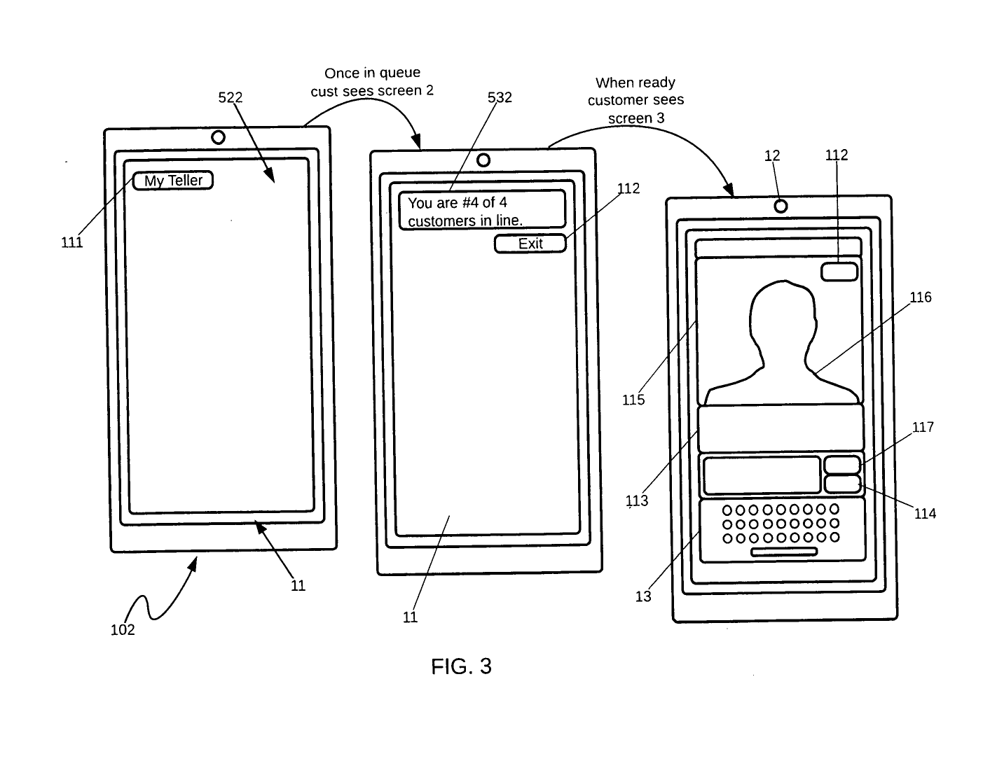

FIG. 3 is a screen depiction of the customer application as utilized with a mobile communication device.

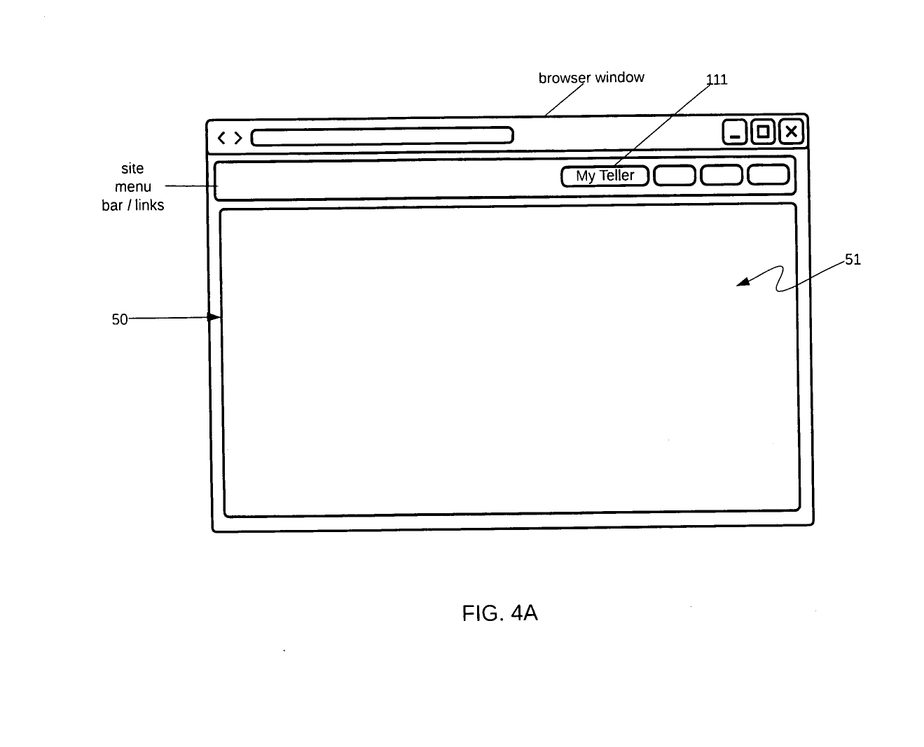

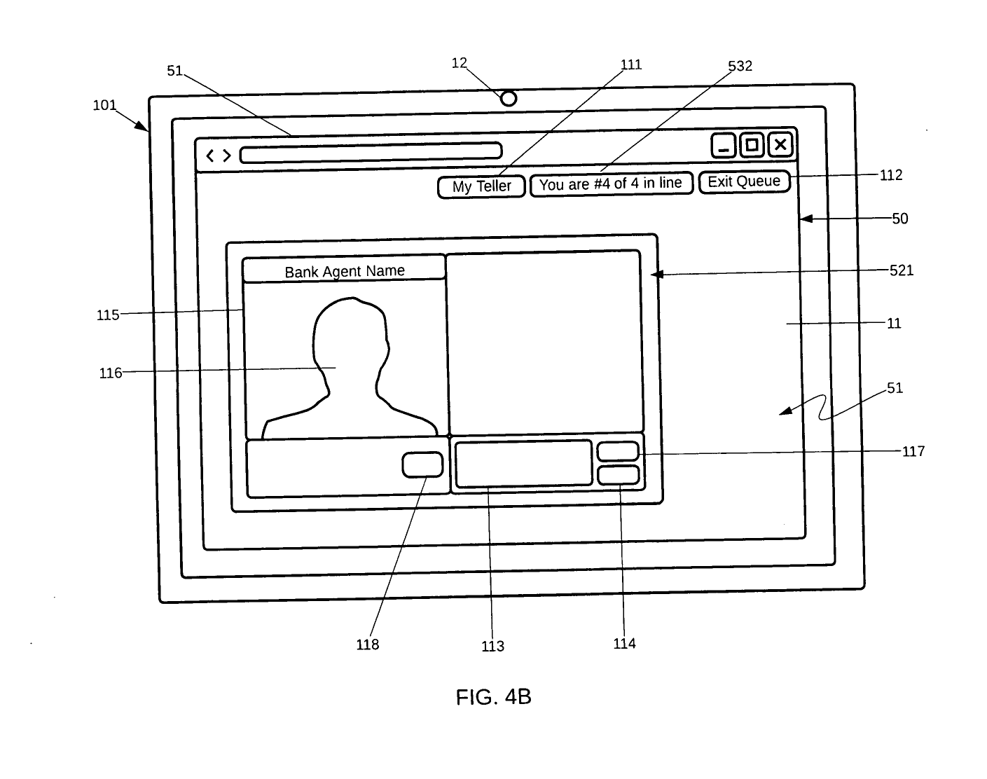

FIG. 4A is a representation of a typical financial institution Internet web page.

FIG. 4B is a screen depiction of the customer application when used with an Internet web page hosted by a financial institution.

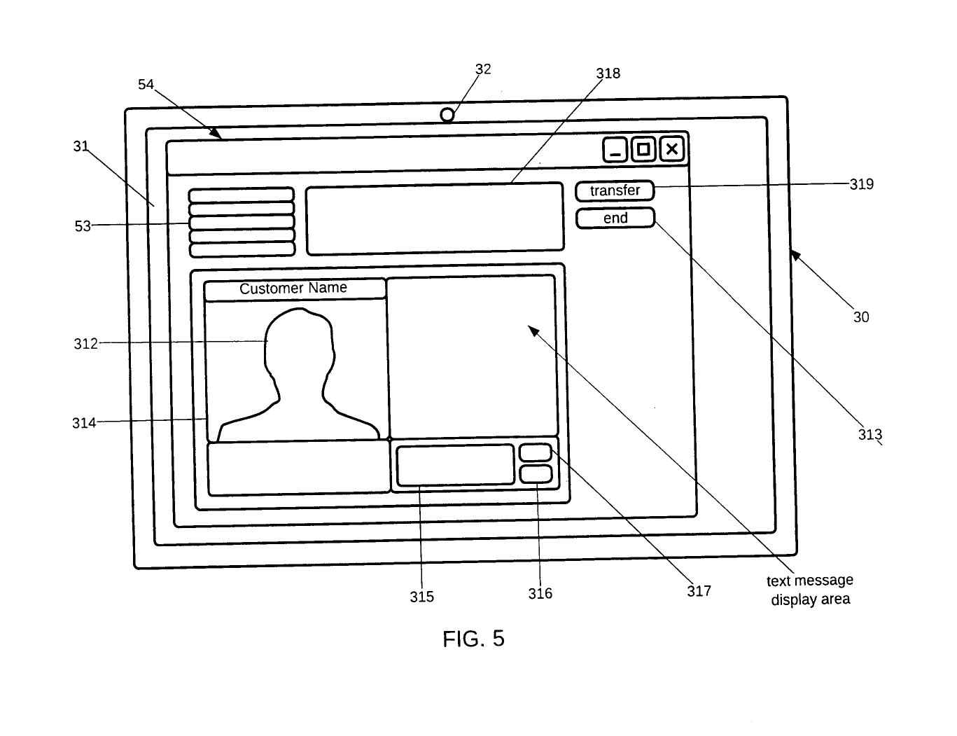

FIG. 5 is a screen depiction of the bank representative application

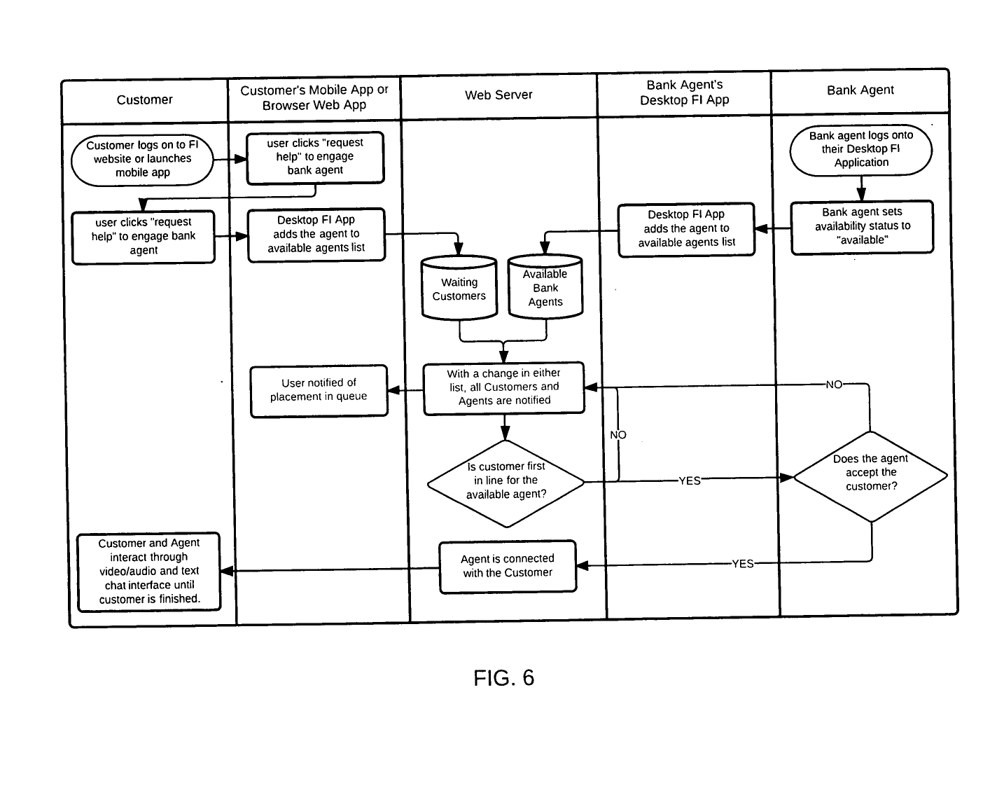

FIG. 6 is a flow diagram showing the steps inherent in an online banking transaction using the present invention

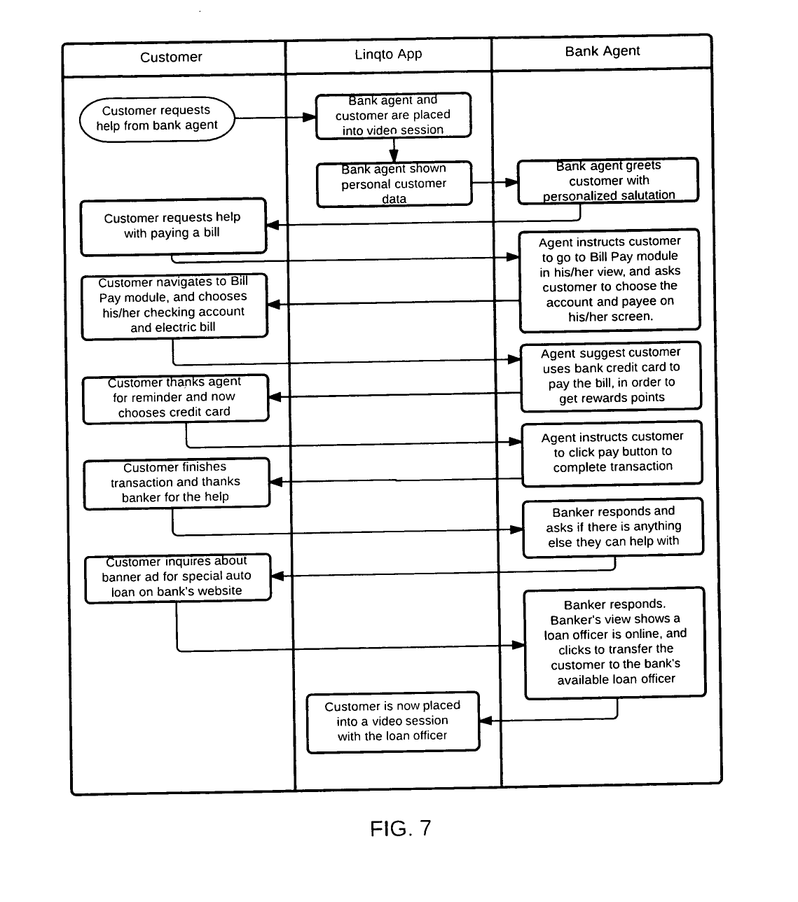

FIG. 7 is a flow diagram showing the steps in an online banking transaction paying bills.

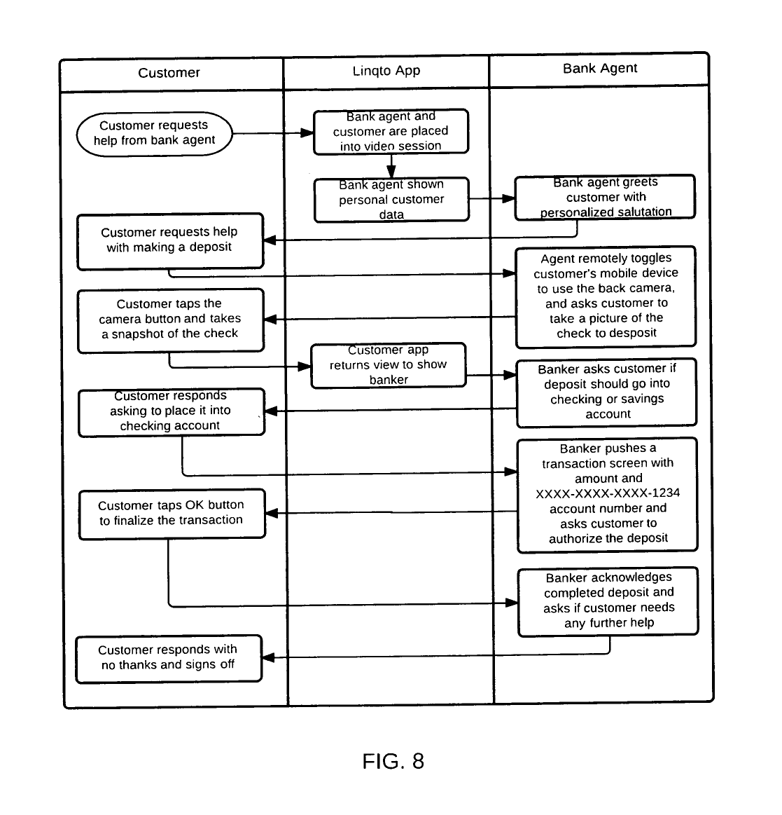

FIG. 8 is a flow diagram showing the steps in an online banking transaction using a mobile communications device.

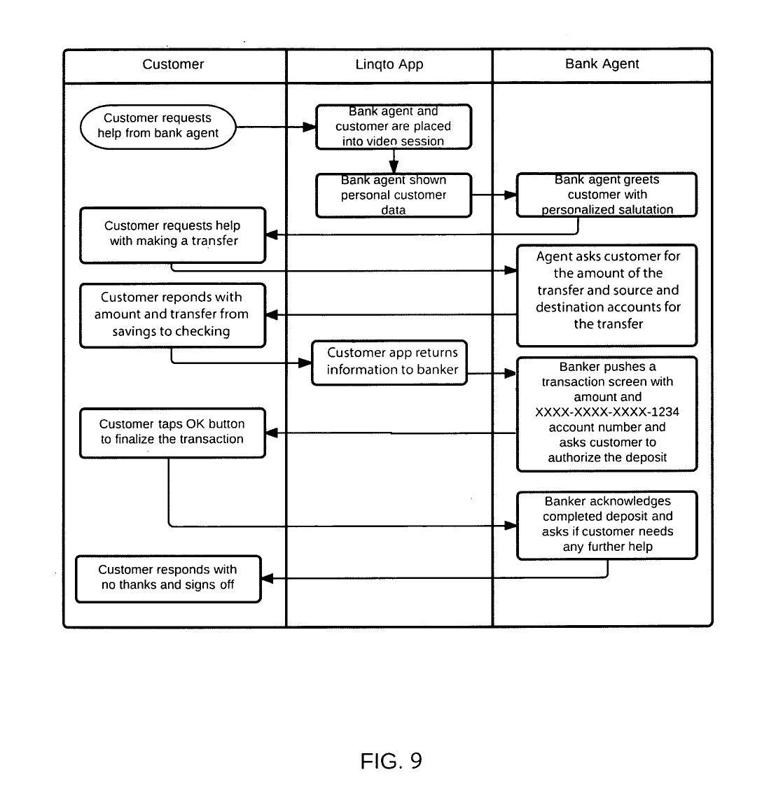

FIG. 9 is a flow diagram showing the steps in an online banking transaction (transfer of funds) using a wearable mobile communication device.

### REFERENCE NUMERALS IN DRAWINGS

10—Personal Communication Device
101—Computer Communications Device
102—Mobile Communications Device
103—Wearable Mobile Communication Device
11—Screen
111—My Teller Button
112—Exit Button
113—Text Message Window
114—Send Text Message Button
115—Video Display
116—Teller's Image
117—Add File or Message Button
118—End Video Session Button
119—Wearable Communication Device Teller Access Button
12—Camera
121—Back Camera (not shown)
13—Keypad
131—Keyboard (not shown)
14—Microphone
20—Server
30—Bank Communication Device
31—Screen
312—Speaker's Image
313—Remove Customer Button
314—Video Display
315—Text Message Window
316—Send Text Message Button
317—Add File or Image Button
318—Customer Information Screen
319—Transfer Customer Button
32—Camera
33—Keypad (not shown)
34—Microphone
40—Online Banking Participants
41—Customer
411—Customer Using a Computer to Bank Online
412—Customer Using a Mobile Communications Device to Bank Online
413—Customer Using a Wearable Mobile Communication Device to Communicate with a Bank Representative
42—Bank Representative (Teller)
421—Bank Officer
43—Speaker
44—Texter
50—Banking Functions
51—Internet Web Site
52—Customer Online Banking Application
521—Computer Online Banking Application
522—Mobile Communications Device Banking Application
523—Wearable Mobile Communication Device Banking Application
53—Customer Queue
530—Agent Repository
5301—Agent Positioning Function
531—Customer Queue Function
532—Customer Queue Status Message
533—Customer Queue Positioning Function
534—Transfer Customer Function
535—Remove Customer Function
54—Desktop Online Financial Services Application
55—Virtual Lobby
551—Virtual Teller Function
56—Speaker's Box
561—Enter Speaker's Box Function
57—Audio-video Chat
570—Audio Chat
571—Video Chat Function
58—Text Message Chat
581—Send Text Message Function
60—Financial Transaction Steps

### DESCRIPTION OF THE INVENTION

### General Description

The present invention is a customer online banking application (52). It is a system, method, and associated computer program for conducting online banking transactions whereby an online customer (41), using a personal communication device (10), engages in live, two-way audio, video, and/or text communication with a human financial institution representative (42) who is using a bank communication device (30). The present invention is written into an application used by a customer using a computer to bank online (411), a customer using a mobile communication device to bank online (412), and/or a customer using a wearable mobile communication device to communication with a bank representative (413), and a bank representative (42) interacting with these customers (411, 412, 413). The application is designed to be compatible with current operating systems such as IOS, Android®, and the like. Further, the application can be modified to be compatible with new operating systems as they are introduced into the marketplace.

The customer using a computer to bank online (411) gains access to the financial institution's financial services (50) by logging onto the institution's Internet website (51) which contains the financial institution's online banking program providing the banking services (50). This customer (411) accesses the computer online banking application (521) which the financial institution has previously installed in its Internet web site (51) by touching or clicking a “widget” ([referred to hereinafter as the “My Teller” button (111) or the “Wearable Mobile Communication Device Teller Access Button (119) as appropriate].

The customer using a mobile communication device to bank online (412) gains access to the financial institution's financial services (50) by activating the financial institution's mobile communication device online banking application (522) which contains the financial institution's online banking program providing the banking services (50). This customer (412) accesses the mobile communication device online banking application (522) which the customer (412) has previously downloaded from the financial institution by touching or clicking (with a stylus) the icon or symbol associated with this application (522).

The present invention also contemplates a customer using a wearable mobile communication device to communicate with a bank representative (413). This wearable mobile communication device (103) could be any type of wearable device providing the user with a digital communication capability such as the newly released Smart Watch®, digital communications eyeglasses such as the recently released Google Glass®, two-way wrist-radios, and the like. The customer using a wearable mobile communication device to communicate with a bank representative (413) gains access to the financial institution's financial services (50) by activating the financial institution's wearable mobile communication device online banking application (523) which contains the financial institution's online banking program providing the banking services (50). This customer (413) accesses the wearable mobile communication device online banking application (523) which the customer (413) has previously downloaded from the financial institution by touching or clicking (with a stylus) the icon or symbol associated with this application (523).

This application (523) is different from the applications (521, 522) associated with the computer communication device (101) and the mobile communication device (102) in that this application (523) only permits audio and video communication between the customer using a wearable communication device to communicate with a bank representative (413) and a bank representative (42) or bank officer (421). The wearable communication devices (103) for which this application (523) is contemplated typically have video screens that are too small to accommodate presentation of financial or other account data. Further, this application is intended to permit the customer using a wearable communication device (413) to use an audio-video link to the bank representative (42) or bank officer (421) to answer questions or perform relatively straightforward financial transactions. As such, the interaction between this customer (413) and the bank representative (42) or bank officer (421) is presently limited to an audio-video interaction.

The bank representative (42) gains access to the financial institution's financial services (50) by activating the financial institution's desktop online financial services application (54) which contains the financial institution's online banking program providing the banking services (50) and connectivity to the customer online banking applications (521, 522, 523).

Once access to the various applications (521, 522, 523, and 54) has been established, communication between the communication devices (101, 102, 103 and 30) is routed through a server (20). The detailed description of these communications follows.

### Detailed Description—Preferred Embodiment

FIG. 1A is a basic flow diagram of the present invention showing the typical online banking participants (40) engaged in an online financial transaction using the present invention. In simplest terms, a personal communications device (10) communicates or interacts with a bank communications device (30) through an Internet server (20).

In this scenario, the online banking participants (40) include a customer (41) and a bank representative (42). A customer (41) of a particular financial institution may wish to engage the services or assistance of a bank representative (42) such as a teller, loan officer, branch manager, or the like. Each customer (41) has a personal communication device (10) such as a desktop computer, a laptop or notebook computer, a mobile phone, or a wearable communication device such as a Smart Watch®, Google Glass®, or the like. Such devices (10) typically have text and/or video conferencing features installed as part of the general configuration of the personal communications device (10). These video and text conferencing features include a screen (11), a digital camera (12) imbedded in or attached to the screen (11), a keypad (13) or keyboard (13) (not shown), and a microphone (14). The personal communications device (10) is configured with a customer online banking application (52) that has been downloaded or installed to permit the customer (41) to conduct banking transactions online or to communicate directly via an audio-video link with a bank representative (42) or a bank officer (421). The customer online banking application (52) connects the personal communications device (10) to the desktop online financial services application (54) installed in the bank communication device (30) through a server (20). In essence, these applications (52, 54) enable the communications devices (10, 30) to exchange digital data and video streams with each other through the server (20).

The bank representative (42) has a bank communication device (30) on his or her own desk which would typically be a desktop computer but could also be a laptop or notebook computer as well. These bank communication devices (30) also have video and text conferencing features installed as part of the general configuration of the personal communications device. These video and text conferencing features include a screen (31), a digital camera (32) imbedded in or attached to the screen (31), a keypad or keyboard (33), and a microphone (34). The bank communications device (30) is configured with a desktop online financial services application (54) that has been downloaded or installed to allow the bank representative (42) to offer an array of online financial services. The desktop online financial services application (54) connects the bank communications device (30) to the customer online banking application application (52) installed in the personal communication device (10) through a server (20). As mentioned above, these applications (52, 54) enable the communications devices (10, 30) to exchange digital data and video streams with each other through the server (20).

FIG. 1B is a basic flow diagram of the present invention showing the interaction of multiple major participants in an online banking transaction. Here we see a customer using a computer to bank online (411) by using a desktop or laptop computer communications device (101) with a computer online banking application (521) downloaded or installed therein. We also see a customer using a mobile communications device to bank online (412) by using a mobile communications device (102) with a mobile communications device online banking application (522) downloaded or installed therein. Although not shown on FIG. 1B, this flow diagram could also accommodate a third type of customer: the customer using a wearable communications device to communicate with a bank representative (413). This customer (413) would be using a wearable communications device (103) with a wearable mobile communication device banking application (523) downloaded or installed therein to communicate with the desktop online financial services application (54) through the server (20).

These customers (411, 412, 413) are presently communicating with more than one bank representative (42) who may be in the same branch or a different branch of this particular financial institution.

The customer using a computer to bank online (411) has a computer communications device (101) such as a desktop or laptop computer that is configured with a computer online banking application (521) that has been downloaded or installed in the computer communications device (101) to permit the customer (411) to conduct banking transactions online using his/her desktop or laptop computer (101). The computer online banking application (521) connects the computer communications device (101) to the desktop online financial services application (54) installed in the bank communication device (30) through a server (20). In essence, these applications (521, 54) enable the communications devices (101, 30) to exchange digital data and video streams with each other through the server (20).

The customer using a mobile communications device to bank online (412) has a personal communications device (102) such as a mobile phone that is configured with a mobile communications device banking application (522) that has been downloaded or installed in the personal communications device (102) to permit the customer (412) to conduct banking transactions online using his/her mobile communications device (102). The mobile communications device banking application (522) connects the mobile communications device (102) to the desktop online financial services application (54) installed in the bank communication device (30) through a server (20). In essence, these applications (522, 54) enable the communications devices (102, 30) to exchange digital data and video streams with each other through the server (20).

The customer (not shown on FIG. 1B) using a wearable mobile communications device to communicate with a bank representative (413) has a wearable mobile communications device (103) such as a Smart Watch®, Google Glass®, two-way wrist radio, or the like that is configured with a wearable mobile communications device banking application (523) that has been downloaded or installed in the wearable mobile communications device (103) to permit the customer (413) to communicate directly with a bank representative (42) or bank officer (421) by audio-video link using his/her wearable mobile communications device (103). The wearable mobile communications device banking application (523) connects the wearable mobile communications device (103) to the desktop online financial services application (54) installed in the bank communication device (30) through a server (20). In essence, these applications (523, 54) enable the communications devices (103, 30) to exchange audio and video streams with each other through the server (20).

FIG. 1B also shows the interconnectivity of multiple bank communication devices (30) through a desktop online financial services application (54) which has been downloaded or installed into the bank communication device (30) of every bank representative (42) authorized by the financial institution to perform online financial transactions with customers (41). As such, every bank representative (42) online when a customer (41) comes online with the financial institution or who accesses the financial institution's desktop online financial services application (54) is available to assist that customer (41). While FIG. 1B only shows two interconnected bank communication devices (30), the present invention accommodates multiple interconnected bank communication devices (30) located in the same and/or multiple branches of that particular financial institution. The present invention also contemplates being able to accommodate personal communication devices (10) other than those (101, 102, 103) disclosed herein.

FIG. 2 is a basic flow diagram of the present invention showing the basic customer (41) and bank representative (42) interaction. FIG. 2 depicts a customer using a mobile communication device (412). In this case, the mobile communication device (102) depicted is a mobile phone. The basic interactions between this customer (412) and the bank representative (42) would be the same for a customer using a computer to bank online (411). This customer (412) gains access to the financial institution's banking functions (50) by activating a previously downloaded customer online banking application (52), which in this case would be the mobile communication device online banking application (522). The customer using a computer to bank online (411) would gain such access by logging onto the financial institution's Internet web site (51).

Although the customer using a wearable mobile communication device to communicate with a bank representative (413) is not depicted in FIG. 2, the steps taken by the customer (412) depicted therein would be similar to the steps taken by the customer using the wearable mobile communication device (413) as depicted in FIG. 2A. In this case, the wearable mobile communication device (103) depicted would be a wearable communication device (103) such as a Smart Watch®, Google Glass®, two-way wrist radio, or the like. The basic audio-video interactions between this customer (413) and the bank representative (42) would be the same as those for a customer using a computer to bank online (411) or the customer using a mobile communication device to bank online (412). This customer (413) gains access to the financial institution's banking functions (50) by activating a previously downloaded customer online banking application (52), which in this case would be the wearable mobile communication device online banking application (523). After gaining access to this online banking application (523) this customer simply, presses the wearable mobile communication device teller access button (119) to signal the financial institution that he/she wishes to engage the services of a bank representative (42) by means of an audio-video transaction.

After this customer (412, 413) has gained access to the financial institution's banking functions (50) with the intent to engage the services of a bank representative (42), he/she would immediately be added to the bank's customer queue (53) and wait in a virtual line in a virtual lobby (55) for the next available bank representative (42) to provide assistance. Similarly, all available bank representatives (42) who are online have been placed in the agent repository (530) in order of availability. The agent repository (530) displays a list of all online/available bank representatives (42) to all other bank representatives so that any given bank representative (42) can transfer a customer (412, 413) he/she is assisting to a specific online bank representative (42) to assist that customer (412, 413) with issues beyond the purview of the present bank representative (42). Otherwise, the first available bank representative (42) in the agent repository (530) would be matched with the customer (412, 413) at the head of the line in the customer queue (53).

The bank representative (42) has also gained access to the financial institution's banking functions (50) by logging onto the financial institution's internal desktop online financial services application (54) which has been installed or downloaded into the bank communication devices (30) of all representatives (42) authorized by the financial institution to conduct online banking services. As mentioned previously, these representatives (42) may be located in the same branch of the financial institution or in multiple branches of that institution since their bank communication devices (30) are all interconnected so as to have access to the desktop financial services application (54) at the same time. The desktop financial services application (54) enables the bank representative (42) to interact directly with this customer (412, 413) in a virtual bank lobby (55). The desktop financial services application (54) also alerts the bank representative (42) to the fact that a customer (412, 413) has entered the bank's customer queue (53). The customer (412, 413) at the head of the line in the customer queue (53) is matched with the first available bank representative (42) who would be at the head of the line in the agent repository (530). The bank representative (42) would then accept this particular customer (412, 413) and begin executing the desired financial transaction. If no bank representative (42) is available, the customer (412, 413) waits in a virtual line in the customer queue (53) until the next available bank representative (42) is ready to accept the next customer (412, 413) in line in the customer queue (53).

When the customer's (412, 413) position is at the front of the line in the customer queue (53) and a bank representative (42) is or becomes available, that customer (412) would immediately be moved electronically into the speakers' box (56) where he/she is immediately in communication with a bank representative (42) through a two-way audio-video chat (57) or, for only the customer using a computer (411) or the customer using a mobile communication device (412), a text message chat (58) with the bank representative (42) to execute the desired transaction(s). When the transaction has been completed, the customer (412, 413) leaves the speaker's box (56) by logging off or closing the financial institution's Internet web site (51) or deactivating the previously downloaded mobile communication device banking application (522). If the customer (412, 413) forgets to exit explicitly, the bank representative (42) can electronically remove that customer (412, 413) and accept the next customer (412, 413) in line in the customer queue (53) and the transaction process is repeated.

FIG. 3 shows three separate screen (11) depictions of the customer application of the present invention as utilized in a financial transaction using a mobile communication device (102). The screen (11) depictions of the other customers (411, 413) would be the same except as noted hereunder. This particular customer (412) is using a mobile communications device (102) such as a mobile phone or cell phone to conduct online banking transactions. The customer (412) has activated the online banking application (522) which had been previously downloaded or otherwise installed in the mobile communication device (102). The customer (412) is presently looking at the screen (11) which shows the initial features of the mobile communications device online banking application (522) and sees the “My Teller” button (111). In the event that the customer (412) desires to speak directly with a human (as opposed to machine-generated) bank representative (42), he/she simply presses or clicks (with a stylus) the “My Teller” button (111). The customer using a wearable mobile communications device (413) would see the wearable mobile communication device teller access button (119) on his/her screen immediately upon accessing the wearable mobile communication device banking application (523). This button (119) would typically be depicted as a prominent circle in the center of the screen (11) and the customer (413) would simply touch that spot to signal his/her desire to engage in an audio-video transaction with a bank representative (42).

Pressing or clicking the “My Teller” button (111) or the wearable mobile communication device teller access button (119) activates the customer queue function (531) which electronically moves the customer (412) into the customer queue (53) in the virtual lobby (55) of the financial institution. Although the customer (412) is in a remote location, the virtual lobby (55) views the customer (412) as if he/she were physically present in the financial institution. Pressing or clicking the “My Teller” button (111) or the wearable mobile communication device teller access button (119) also activates the virtual teller function (551) which alerts a bank representative (42) to the fact that a new customer (412) is entering the customer queue (53). As mentioned previously, if no other customer (411, 412, 413) is in the customer queue (53) and an online bank representative (42) is available, this customer (412) would immediately and electronically be placed in the speaker's box (56) to begin his/her communication with the bank representative (42).

Once the customer (412) is in the customer queue (53) he/she sees a new message on the screen (11). This is the queue status message (532) which indicates the customer's (412) position in the customer queue (53) relative to the other online banking customers (41). The second screen (11) in FIG. 3 is displaying a message (532) that this customer (412) is in position number four behind three other customers (41); this customer (412) is at the end of the line in this particular customer queue (53). The queue status message (532) may also indicate the estimated waiting time before the next bank representative (42) is available.

Positioning the customer (412) in the customer queue (53) is another innovative feature of the present invention. As the customer (412) is electronically moved into the customer queue (53), that customer (412) is automatically positioned in the customer queue (53) with respect to other online banking customers (411, 412, 413) by the customer queue positioning function (533). The customer queue positioning function (533) arranges online customers (411, 412, 413) in the customer queue (53) in the order in which they entered the customer queue (53). Since this customer (412) just entered the customer queue (53), his/her relative position in line is fourth in line behind three online customers (411, 412, 413) who were in the customer queue (53) ahead of him/her. If the customer (412) does not want to wait in line to speak with a bank representative (42), he/she can simply press or click the exit button (112) which electronically closes down or terminates the mobile communications device online banking application (522). If the customer using a wearable mobile communications device (413) does not want to wait in line to speak with a bank representative (42), he/she can simply close the online banking application (523) manually thereby terminating the session.

While the bank representative (42) is the first person to engage this particular customer (412), he/she may not be able to answer all of the customer's (412) questions or perform the desired service such as open a new account, apply for a loan, or the like. This bank representative (42) can transfer the customer (412) to another available bank representative (42) or a bank officer (421) in the same branch or another branch by using the transfer customer function (534). The transfer customer function (534) electronically matches the customer (412) with another available bank representative (42) or bank officer (421) with sufficient experience, expertise, or authority to assist that customer (412). The bank representative (42) would review the agent repository (530) (see FIG. 2) to ascertain which representatives (42) and/or officers (421) are available and electronically match and transfer the customer (412) needing additional assistance to that other available bank representative (42) or bank officer (421).

If one or more bank representatives (42) are available when the customer (412) enters the customer queue (53), the enter speaker's box function (561) will automatically and immediately move that customer (412) into the speaker's box (56). If the customer (412) chooses to wait in the customer queue (53), the enter speaker's box function (561) will automatically move the customer (412) electronically from the customer queue (53) into the speaker's box (56) when that customer's (412) turn to speak has come up. Once in the speaker's box (56), the customer (412) is now the speaker (43) who may speak directly to a living, human bank representative (42).

In essence, the customer using a mobile communication device to bank online (412) has only one button, the “My Teller” button (111) that puts that customer (412) into “the opportunity to speak” mode with a bank representative (42). Similarly, the customer using a wearable mobile communication device to communicate with a bank representative (413) has only one button, the wearable mobile communication device teller access button (119) that puts that customer (413) into “the opportunity to speak” mode with a bank representative (42). Clicking that button (113, 119) will either place the customer (411, 412, 413) directly into the speaker's box (56) if a bank representative (42) is available or into the customer queue (53) if one is not, where the customer (411, 412, 413) would wait in line for the next available bank representative (42).

Once in the speaker's box (56), the customer (411, 412) would initially have capabilities of audio-video chat (57) and text chat (58) by default. The customer using a wearable mobile communication device (413) would be limited to the audio-video chat option only. For privacy situations, the customer (411, 412) could “turn off” the audio-video chat (57) portion and communicate with the bank representative (42) by text chat (58) only. In the cases where bandwidth was insufficient for audio-video chat (57) communication, the mobile communication device online banking application (522) would automatically change it to suppress the video portion of the audio-video chat (57) so the customer (41) could continue the communication audio chat (571) and, for the first two customer types (411, 412) text chat (58).

At the same time that the customer (412) enters the speaker's box (56), the display virtual teller function (552) in the bank communication device (30) begins sending a video stream from the bank communication device (30) to the mobile communications device (102) and the virtual teller function (552) in the mobile communication device (102) begins sending a video stream to the bank communication device (30). A live video stream of a video image, including the teller's image (116) is being routed through the server (20) and then transmitted to the mobile communication device (102). Similarly, live video stream of the speaker's image (312) is being routed through the server (20) and then transmitted to the bank communication device (30).

The speaker (43), who could be any one of the customers (411, 412, 413), now sees the screen (11) presentation shown on the right-hand side of FIG. 3. Once the speaker (43) is in the speaker's box (56), the screen (11) on his/her mobile communications device (102) will now show an on-screen keypad (13) which would allow the speaker (43) to engage in a text message chat (58) with the bank representative (42), a text message window (113) which displays the text message chat (58), a send text message button (114) which allows the speaker (43) to send his/her text message to the bank representative (42), a video display (115) which shows the bank representative's surroundings (office, desk, etc.) as well as the bank representative's image (116) which is a live video image that is being streamed from the bank communication device (30) to the mobile communication device (102) by the desktop online financial transaction application (54), and finally, an add file or image button (117) which allows the speaker (43) to send a file, such as a deposit or withdrawal slip or an image, such as the image of a check to deposit. When the customer (412) engages in a two-way text message chat (58), he/she would become a Texter (44). As mentioned previously, these texting options are not available to the customer using a wearable communication device (413) because of the size limitations of the screen (11) on his/her wearable mobile communication device (103). Similarly, these filing and imaging options are not available to the customer using a wearable communication device (413) because of the size limitations of the screen (11) on his/her wearable mobile communication device (103).

While the bank representative's image (116) is being displayed on the speaker's (43) screen (11), the speaker's image (312) is simultaneously displayed on the bank representative's screen (31) (see FIG. 5 below). Both images (116, 312) are captured by the cameras (12, 32) located on or imbedded in the mobile communications device (102) and the bank communication device (30) and then transmitted to the other communications device by a live video feed routed through the server (20). This live video image of the bank representative (42) represents a significant improvement over the devices taught by the prior art. It humanizes and personalizes the financial transaction whereas the devices taught by the prior art disclose improved methods of customers (41) communicating with their financial institutions' computers programmatically instead of communicating directly with the employees and representatives of that financial institution.

It also provides an improvement to the security of the transaction since the transaction is conducted with a human being which minimizes the risk of unauthorized access to the transaction by a third party. And since the bank representative (42) is entering the transaction locally on the bank's computer pursuant to the customer's (41) instructions, sensitive financial information does not have to be transmitted over the Internet. In this manner, this transaction is executed with the same level of security as an actual visit to the bank. The customer (41) now has the choice in a digital banking transaction of executing it programmatically using the bank's digital software (which has been discussed in reviewing the prior art) or executing it directly by instruction to a bank representative (as contemplated by the present invention).

While the speaker (43) is in the speaker's box (56) he/she can carry on an audio-video chat (57) conversation with the bank representative (42) by simply speaking into his/her microphone (14) while looking at his/her camera (13). Similarly, the bank representative can carry on an audio-video chat (47) conversation with the speaker (43) by simply speaking into his/her microphone (34) and looking into his/her camera (33).

When the speaker (43) has completed his/her business of speaking with the bank representative (42) while using the mobile communication device online banking application (522) to transfer funds, pay bills, and the like, he/she can simply press or click the exit button (112) which electronically closes down or terminates the mobile communications device online banking application (522). If the customer (412) desires to end the video session but remain online, he/she can touch or press the end video session button (118) which terminates the video session with the bank representative (42) but permits the customer (412) to continue using the features on the financial institution's website (51). If the customer using a wearable mobile communications device (413) wishes to end the audio-video session with the bank representative (42), he/she can simply close the online banking application (523) manually and thereby terminate the session.

If the customer (412) forgets to exit explicitly, the bank representative (42) can electronically remove that customer (412) and accept the next customer (412) in line in the customer queue (53) and the transaction process is repeated. The bank representative accomplishes this by touching or clicking the remove customer key (313) on his/her screen (32). This activates the remove customer function (535) which electronically removes the latest customer (412) from the speaker's box (56) so that the next customer (412) in line in the customer queue (53) can be moved into the speaker's box (56).

Once the latest customer (412) has exited the speaker's box (56) the next customer (412) in line in the customer queue (53) is automatically and electronically moved into the speaker's box (56) and the process of conducting the banking transaction is repeated.

FIG. 4A is a diagram of a typical financial institution website (51) hosting online banking services and one which would be typically used by a customer using a computer to bank online (411). This customer (411) is performing an online banking transaction using a computer communications device (101) such as a desktop or laptop computer. In this scenario, the customer (411) has gained access to the financial institution's banking functions (50) by logging onto the financial institution's Internet web site (51). If the customer (411) does not desire to engage the services of a live bank representative (42), he simply concludes his transaction(s) and then logs off or closes the financial institution's Internet web site (51). However, the present invention gives the customer (411) the option of speaking with a live bank representative (42) to receive answers to questions, obtain additional information, or just interact with a person instead of a machine. The customer need only click on the “My Teller” button (111) to activate the process.

FIG. 4B shows the screen (11) on the customer's (411) personal communications device (10), which, in this scenario, is a computer communications device (101) such as a desktop or laptop computer. As noted above, the customer (411) has gained access to the financial institution's banking functions (50) by logging onto the financial institution's Internet web site (51). The Internet web site (51) page shown in FIG. 4A represented a generic configuration for conducting online banking transactions. The new features contemplated by the present invention can be seen on the exemplar depicted by FIG. 4B. The customer (411) had signaled his/her desire to speak with a bank representative (42) by pressing or clicking on the “My Teller” button (111). This alerts the bank representative (42) to the fact that an online customer (411) desires to speak to or otherwise engage a bank representative (42). Pressing or clicking the “My Teller” button (111) activates the customer queue function (531) which electronically moves the customer (411) into the customer queue (53) in the virtual lobby (55) of the financial institution. Although the customer (411) is in a remote location, the virtual lobby (55) views the customer (411) as if he/she were physically present in the financial institution. Pressing or clicking the “My Teller” button (111) also activates the virtual teller function (551), which alerts a bank representative (42) to the fact that a new customer (411) is entering the customer queue (53).

Once the customer (411) is in the customer queue (53) he/she sees a new message on the screen (11) stating: “Waiting for Agent, You are #4”. This is the queue status message (532), which indicates the customer's (411) position in the customer queue (53) relative to the other online banking customers (41). The queue status message (532) tells this customer (411) that he/she is in position number four behind three other customers (41); this customer (411) is at the end of the line in this particular customer queue (53). The queue status message (532) may also indicate the estimated waiting time before the next bank representative (42) is available.

As with the mobile communication device (102), positioning the customer (411) in the customer queue (53) is another innovative feature of the present invention. As the customer (411) is electronically moved into the customer queue (53), that customer (411) is automatically positioned in the customer queue (53) with respect to other online banking customers (41) by the customer queue positioning function (533). The customer queue positioning function (533) arranges customers (41) in the customer queue (53) in the order in which they entered the customer queue (53). Since this customer (411) just entered the customer queue (53), his/her relative position in line is fourth in line behind three customers (41) who were in the customer queue (53) ahead of him/her. Similarly, the agent positioning function (5301) positions the bank representatives (42) in the agents' queue (530) in order of availability (referring back to FIG. 2). If the customer (411) does not want to wait in line to speak with a bank representative (42), he/she can simply press or click the exit button (112) which electronically closes down or terminates the computer communications device online banking application (521).

While the bank representative (42) is the first person to engage this particular customer (411), he/she may not be able to answer all of the customer's (411) questions or perform the desired service such as open a new account, apply for a loan, or the like. This bank representative (42) can transfer the customer (411) to another available bank representative (42) or a bank officer (421) in the same branch or another branch by using the transfer customer function (534). The transfer customer function (534) electronically matches the customer (411) with another available bank representative (42) or bank officer (421) with sufficient experience, expertise, or authority to assist that customer (411). The bank representative (42) would review the agent repository (530) (see FIG. 2) to ascertain which representatives (42) and/or officers (421) are available and electronically match and transfer the customer (411) needing additional assistance to that other available bank representative (42) or bank officer (421).

If one or more bank representatives (42) are available when the customer (411) enters the customer queue (53), the enter speaker's box function (561) will automatically and immediately move that customer (411) into the speaker's box (56). If the customer (411) chooses to wait, the enter speaker's box function (561) will automatically and electronically move the customer (411) from the customer queue (53) into the speaker's box (56) when that customer's (411) turn to speak has come up. Once in the speaker's box (56), the customer (412) is now the speaker (43) who may speak directly to a living, human bank representative (42).

As with the customer using a mobile communications device to bank online (412), the customer using a computer to bank online (411) has only one button, the “My Teller” button (111) that puts that customer (411) into “the opportunity to speak” mode with a bank representative (42). Clicking that button (111) will either place the customer (411) directly into the speaker's box (56) if a bank representative (42) is available or into the customer queue (53) if one is not, where the customer (411) would wait in line for the next available bank representative (42). Once in the speaker's box (56), the customer (411) would initially have capabilities of audio-video chat (57) and text chat (58) by default. For privacy situations, the customer (411) could “turn off” the audio-video chat (57) portion and communicate with the bank representative (42) by text chat (58) only. In the cases where bandwidth was insufficient for audio-video chat (57) communication, the computer online banking application (521) would automatically change it to suppress the video portion of the audio-video chat (57) so the customer (411) could continue the communication using audio chat (571) and text chat (58).

At the same time that the customer (411) enters the speaker's box (56), the display virtual teller function (552) in the bank communication device (30) begins sending a video stream from the bank communication device (30) to the computer communications device (101) and the virtual teller function (552) in the computer communication device (101) begins sending a video stream to the bank communication device (30). A live video stream of the teller's image (116) is being routed through the server (20) and then transmitted to the computer communication device (101). Similarly and looking ahead to FIG. 5, live video stream of the speaker's image (312) is being routed through the server (20) and then transmitted to the bank communication device (30).

The speaker (43) now sees the screen (11) presentation shown in FIG. 4B which is one of the many variants of how the computer online banking application (521) can be displayed. These variations would also be available with the previously discussed mobile communication device banking application (522). Once the speaker (43) is in the speaker's box (56), the screen (11) on his/her computer communications device (101) will now show a text message window (113) which would allow the speaker (43) to engage in a text message chat (58) with the bank representative (42) using his keypad (13) which, for this configuration, would be likely be a keyboard (131) electrically connected to the computer communication device (101). The text message window (113) displays the text message chat (58) and a send text message button (114) allows the speaker (43) to send his/her text message to the bank representative (42) by simply touching or clicking on that button (114). While the speaker (43) is using this feature, he/she becomes a Texter (44). The screen (11) also has a video display (115) which shows the bank representative's surroundings (office, desk, etc.) as well as the bank representative's image (116) which is a live video image that is being streamed from the bank communication device (30) to the computer communication device (101) by the desktop online financial transaction application (54), and finally, an add file or image button (117) which allows the speaker (43) to send a file, such as a deposit or withdrawal slip or an image, such as the image of a check to deposit.

While the bank representative's image (116) is being displayed on the speaker's (43) screen (11), the speaker's image (312) is simultaneously displayed on the bank representative's screen (31) (see FIG. 5 below). Both images (116, 312) are captured by the cameras (12, 32) located on or imbedded in the computer communications device (101) and the bank communication device (30) and then transmitted to the other communications device by a live video feed routed through the server (20). As mentioned previously, this live video image of the bank representative (42) represents a significant improvement over the devices taught by the prior art. It humanizes and personalizes the financial transaction whereas the devices taught by the prior art disclose improved methods of customers (41) communicating with their financial institutions' computers programmatically instead of communicating directly with the employees and representatives of that financial institution.

Again, it also provides an improvement to the security of the transaction since the transaction is conducted with a human being which minimizes the risk of unauthorized access to the transaction by a third party. And since the bank representative (42) is entering the transaction locally on the bank's computer pursuant to the customer's (41) instructions, sensitive financial information does not have to be transmitted over the Internet. In this manner, this transaction is executed with the same level of security as an actual visit to the bank. The customer (41) now has the choice in a digital banking transaction of executing it programmatically using the bank's digital software (which has been discussed in reviewing the prior art) or executing it directly by instruction to a bank representative (as contemplated by the present invention).

While the speaker (43) is in the speaker's box (56) he/she can carry on a conversation with the bank representative (42) by simply speaking into his/her microphone (14). Similarly, the bank representative can carry on a conversation with the speaker (43) by simply speaking into his/her microphone (34).

When the speaker (43) has completed his/her business of speaking with the bank representative (42) while using the computer communication device online banking application (521) to transfer funds, pay bills, and the like, he/she can simply press or click the exit button (112) which electronically closes down or terminates the computer communications device online banking application (521). If the customer (411) desires to end the video session but remain online, he/she can touch or press the end video session button (118) which terminates the video session with the bank representative (42) but permits the customer (411) to continue using the features on the financial institution's website (51).). If the customer (412) forgets to exit explicitly, the bank representative (42) can electronically remove that customer (411) and accept the next customer (411) in line in the customer queue (53) and the transaction process is repeated. The bank representative accomplishes this by touching or clicking the remove customer button (313) on his/her screen (32). This activates the remove customer function (535) which electronically removes the latest customer (411) from the speaker's box (56) so that the next customer (411) in line in the customer queue (53) can be moved into the speaker's box (56).

Once the latest customer (411) has exited the speaker's box (56) the next customer (411) in line in the customer queue (53) is automatically and electronically moved into the speaker's box (56) and the process of conducting the banking transaction is repeated.

When the bank representative (42) is ready to accept the next customer (411) waiting in the customers' queue (53), he/she, as with the transactions dealing with the customer using a mobile communication device to bank online (412), highlights the customer (41) at the head of the line in the speaker's queue (53) and then presses or clicks the enter speaker's box key (311) which initiates the enter speakers' box function (313) on behalf of the next customer (41) in line.

FIG. 5 is a depiction of the desktop online financial services application (54) as it appears on the screen (31) of a bank communication device (30). At this point in time, a customer image (312) is seen on the left-hand side of the bank representative's (42) video display (314) which means that the customer (41) is already in the speaker's box (56) and either speaking or texting with the bank representative (42). As mentioned previously, the texting option is not available to the customer using the wearable mobile communication device (413). The customer's (41) name is displayed above the customer image (312) for ease of reference. A text message window (315) displays newly typed outgoing text messages from the bank representative (42) while the right-hand side of the video display (314) displays incoming text messages. A send text message button (316) is seen to the right of the text message window (315) as is the add file or image button (317). The send text message button (316) allows the bank representative (42) to send his/her text message to the customer (41) while the add file or image button (317) which allows the bank representative (42) to send a file or form to the customer (41). The customer information screen (318) contains pertinent information about the present customer (41) such as name, address, account number(s), account balance(s), and the like to facilitate the transaction. It could also contain personal information such as names of family members, birthdates and anniversary dates, and the like to further personalize the transaction. To the right of the customer information screen (318) is the remove customer key (313) which allows the bank representative to end the video session with the customer (41) or terminate a customer online banking application (52) in the event a departing customer (41) does not exit explicitly.

The transfer customer button (319) allows the bank representative to transfer a customer (41) to another bank representative (42) or bank officer (421) by activating the transfer customer function (534). As mentioned previously, the transfer customer function (534) electronically matches the customer (41) with another available bank representative (42) or bank officer (421) with sufficient experience, expertise, or authority to assist that customer (41). The bank representative (42) would review the agent repository (530) (see FIG. 2) to ascertain which representatives (42) and/or officers (421) are available and electronically match and transfer the customer (41) needing additional assistance to that other available bank representative (42) or bank officer (421). Directly above the video display (314) is a graphic representation of the customer queue (53) so that every bank representative (42) is aware of the number of customers (41) waiting in line in the customer queue (53).

While the bank customer's image (312) is being displayed on the bank representative's (42) screen (31), the bank representative's image (116) is simultaneously displayed on the customer's screen (11) (see FIG. 4A above). Both images (116, 312) are captured by the cameras (12, 32) located on or imbedded in the mobile communications device (102) and the bank communication device (30) and then transmitted to the other communications device by a live video feed routed through the server (20). The live video images (116, 312) of the bank representative (42) and the customer (41) represent a significant improvement over the devices taught by the prior art. It humanizes and personalizes the financial transaction whereas the devices taught by the prior art disclose improved methods of customers (41) communicating with their financial institutions' computers programmatically instead of communicating directly with the employees and representatives of that financial institution. It also provides an improvement to the security of the transaction since the transaction is conducted with a human being which minimizes the risk of unauthorized access to the transaction by a third party.

### Operation of the Preferred Embodiment

FIG. 6 is a generic and descriptive flow diagram showing the steps in an online banking transaction using the present invention. The major parties to the online banking transaction are the customer (41) and the bank agent or representative (42).

The customer (41) has a communication device (10) that is either a computer communication device (101) such as a desktop or laptop computer or a mobile communications device (102) such as a mobile phone. The computer communication device (101) utilizes the bank's website which has been configured to include the present invention. The mobile communication device (102) will have downloaded and installed the present invention embodied in a customer online banking application. Accordingly, the computer online banking application (521) has been included in the bank's customer website (51) in the computer communication device (101) while the mobile communication device banking application (522) has been downloaded or installed in the mobile communication device (102). FIG. 6 refers to these as the Browser Web App [computer online banking application (521)] and the Customer's Mobile App [mobile communication device banking application (522)].

The bank representative (42) and bank officer (421) have a bank communication device (30) that is typically a desktop computer. The bank communications device has downloaded or installed the present invention embodied in a desktop online financial services application (54). FIG. 6 refers to this as the Bank Agent's Desktop FI App [desktop online financial services application (54)].

These applications (521, 522, and 54) communicate with each other through the server (20). They exchange digital data messages and live video stream images for the duration of the online banking transaction.

The process begins when the customer (41) logs onto the financial institution website (51) to access the computer online banking application (521) or activates (launches) the mobile communication device banking application (522) and then logs onto the financial institution's website. Meanwhile, the bank agent or representative (42) logs onto the desktop online financial services application (54).

The bank agent or representative (42) sets his/her availability status as “available” and is placed in the agent repository (530) by the desktop online financial services application (54). This is accomplished through activation of the agent positioning function (5301) which positions all available bank representatives in the agent repository (530) in the order in which they become available to assist online banking customers (41).

If the customer (41) desires to virtually meet through a two way video chat (57) or text chat (58), he clicks or presses the “My Teller” button (111) on his/her screen (11). Clicking or pressing this button (111) signals the computer online banking application (521) or the mobile communication device banking application (522) that the customer (41) is requesting help to engage a bank representative (42). It also activates the customer queue function (531) which immediately and electronically places the customer (41) requesting assistance into the customer queue (53). All customers (41) requesting such assistance are chronologically placed in the customer queue (53) in the order in which they entered. Accordingly, the latest customer (41) entering the queue (53) would be at the end of the line, just as they would be in an actual line in a bank.

At the same time the customer (41) enters the customer queue (53), the desktop online financial services application (54) communicates with the computer online banking application (521) or the mobile communication device banking application (522) to advise it that the customer (41) is in a specific position in the queue (53) and that the approximate waiting time is a given amount. The computer online banking application (521) or the mobile communication device banking application (522) advises the customer of these items by means of the customer queue status message (532) which notifies each customer (41) of his/her position (placement) in the customer queue (53) and the approximate waiting time until a bank representative (42) is available to assist that particular customer (41).

A change in the status of either of the two lists, the customer queue (53) or the agent repository (530), will trigger the customer queue positioning function (533) which moves each customer (41) forward in the virtual line in the queue (53). Simultaneously, the customer queue function (531) is automatically activated thereby sending the customer (41) at the head of the line in the queue (53) into the speaker's box (56) where he/she can begin communication with the bank representative (42). The customer positioning function (533) will also update the customer queue status message for each customer (41) still waiting in the customer queue (53).

Such a change in status occurs when a financial transaction is completed and a customer exits the speaker's box (56) thereby allowing the computer online banking application (521) or the mobile communication device banking application (522) to move the customer (41) who is first in line in the queue (53) into the speaker's box (56) thereby decreasing the number of people in the queue (53). It would also occur when a new bank representative (42) comes online and signals that he/she is available to assist customers (41).

When any customer (41) is first in line in the customer queue (53) the computer online banking application (521) or the mobile communication device banking application (522) will communicate with the desktop online financial services application (54) to determine if there is a bank representative (42) available to assist the customer (41) and if he/she is in a position to accept that customer (41).

If the answer is yes, the computer online banking application (521) or the mobile communication device banking application (522) and the desktop online financial services application (54) will match (connect) that customer (41) who is first in line in the queue (53) with the first bank representative (42) in line in the agent repository (530) so that the customer (43) and the bank representative (42) may interact through an audio-video chat (57), or text chat (58) interface until the customer (41) is finished. If the answer is no, the customer (41) will remain at the head of the line in the customer queue (53) to wait for the next available bank representative (42).

FIGS. 7 and 8 are basic flow diagrams of the bank representative application showing the options available to a bank representative (42) assisting a customer (41) performing an online banking transaction. FIG. 7 is an example of a banker-assisted transaction (paying a bill online) after the customer (41) has gained access to the financial institution's Internet web site (51):
1. Customer (41) requests assistance from a banker (42) by clicking or pushing the “My Teller” button (111) on his/her customer communication device (10) (customer view). After customer (41) has been connected to a bank representative (42), the dialogue begins.
2. Banker (42) views the customer information screen (318) on his/her screen (31) and responds with personalized salutation (banker view with personal customer data showing).
3. Customer (41) requests help with paying a bill (customer has the “Bill Pay Module,” which is one of the online financial services provided by the financial institution, in his/her view)
4. Banker (42) asks customer (41) which account the customer (41) wishes to use, the amount of the payment and the payee.
5. Customer (41) chooses to pay $232.52 form his/her checking account to pay the electric bill due to PG&E.
6. Banker (42) suggests to customer (41) that using their bank credit card to pay the bill will provide customer (41) with rewards points.
7. Customer (41) thanks banker for the reminder and chooses the credit card option instead.
8. Banker (42) instructs customer (41) to click a button to authorize the transaction. Banker (42) completes the transaction on behalf of the customer (41).
9. Customer (41) thanks banker (42) for the help.
10. Banker (42) responds and asks if there is anything additional that they can help with.
11. In customer's (41) view, there is a banner ad from the bank regarding a special auto loan deal being run by the bank. Customer (41) inquires about it.
12. Banker (42) responds and advises customer (41) that he/she will be transferred to a bank officer or loan officer (421) who specializes in this type of transaction. Bank representative clicks or touches the transfer customer button (319) on his/her screen which activates the transfer customer function (534) in order to transfer customer (41) to a loan officer (421) who is online in the banker's (42) view.

13. Loan Officer (421) interacts with the customer (41) about the auto loan and the bank representative (42) engages the next customer (41) waiting in the customer queue (53).

FIG. 8 depicts another example of a banker-assisted transaction (depositing a check) where the customer (41) is connecting to the customer online banking application (52) using a mobile communication device (102). The transaction would take place as follows:
1. Customer (412) requests assistance from a banker (42) by clicking or pushing the “My Teller” button (111) on his/her mobile communication device (102) (customer view). After customer (412) has been connected to a bank representative (42), the dialogue begins.
2. Banker (42) views the personal information screen (318) on his/her screen (31) and responds with personalized salutation (banker view with personal customer data showing). The personal salutation has a location specific comment derived from the mobile communication device banking application's (522) location aware service.
3. Customer (41) requests help with making a deposit.
4. Banker (42) remotely toggles customer's (41) mobile communication device (102) to use the back camera (121) and asks customer (41) to take a picture of the check to be deposited.
5. Customer (41) taps the camera (12) button and takes snapshot of a check.
6. The mobile communication device banking application (522) switches from back view of the check to a front view and shows it to the banker (42). Banker (42) asks customer (41) whether it goes into their checking or savings account.
7. Customer (41) responds to ask it to be placed into their checking account.
8. Banker (42) pushes a transaction screen with amount and XXXX-XXXX-XXXX-1234 account number and requests customer (41) to authorize the deposit.
9. Customer (41) taps the OK button and the banker (42) finalizes the transaction.
10. Banker (42) acknowledges the completed deposit and asks customer (41) if they need any further help.
11. Customer (41) responds with no thanks and signs off.

### Description—Alternative Embodiments

FIGS. 7 and 8 represent two of the literally hundreds of online banking transactions accommodated by the present invention. Paying bills and depositing checks using an online banking function are two of the more common transactions but the present invention can accommodate any type of transaction normally conducted while physically in a financial institution. This includes, without limitation, applications for loans (as suggested by the scenario depicted in FIG. 7), loan payments, transfers of funds between and among accounts, opening or closing accounts, and the like.

FIG. 9 depicts an example of this type of banker-assisted transaction (transferring funds between accounts) where the customer (413) is connecting to the customer online banking application (52) using a wearable mobile communication device (103). The transaction would take place as follows:
1. Customer (413) requests assistance from a banker (42) by clicking or pushing the wearable mobile communication device teller access button (119) on his/her wearable mobile communication device (103) (customer view). After customer (413) has been connected to a bank representative (42), the dialogue begins.
2. Banker (42) views the personal information screen (318) on his/her screen (31) and responds with personalized salutation (banker view with personal customer data showing). The personal salutation has a location specific comment derived from the mobile communication device banking application's (523) location aware service.
3. Customer (413) requests help with transferring funds from one account to another.
4. Banker (42) asks customer (413) to identify the amount to be transferred, the account from which the funds are to taken from, and the account into which the funds are to be transferred.
5. Customer (413) responds and identifies the amount to be transferred, the account from which the funds are to taken from, and the account into which the funds are to be transferred.
6. Banker (42) pushes a transaction screen on his her screen (31) and types in the amount to be transferred, the respective account numbers, and requests the customer (413) to authorize the transfer.
7. Customer (413) verbally authorizes the transfer of funds and the banker (42) finalizes the transaction.
8. Banker (42) acknowledges the completed transfer and asks customer (413) if they need any further help.
9. Customer (413) verbally responds with no thanks and signs off.

As previously noted, the embodiment used by the customer with the wearable mobile communication device (413) does not entail the more complex features of the preferred embodiment such as texting, viewing account information, and the like. Instead, it offers the customer (413) the opportunity to remotely engage a bank representative (42) using an audio-video link to conduct an on-request banking transaction such as providing information about accounts, transferring funds between accounts, stopping payment on a check, and the like. It uses an online banking application (523) that connects to the financial institution's desktop online financial services application (54) through the same router (20) used by the other embodiments, but its features are limited to an audio-video data stream that permits real-time engagement with a live person, the bank representative (42). Because the bank representative is using the financial institution's desktop online financial services application (54), he/she has access to the customer's (413) financial records and can provide the services/information requested by the customer (413) as if that customer (413) was physically in the financial institution with the bank representative (42). Accordingly, the banking functions (50) related to queuing, speaker placement, virtual teller, virtual lobby and the like that are found in the computer and mobile communication device applications (521, 522) are also found in this application (523).

This disclosure describes the present invention in terms of an application downloaded or installed in a computer such as a desktop or laptop computer, a mobile communication device such as a mobile phone, or a wearable mobile communication device such as a Smart Watch®, Google Glass®, two-way wrist radio, or the like. As new communication devices enter the stream of commerce, the present invention can foreseeably be downloaded or installed into any such communication device capable of establishing a connection to the Internet or some other electronic (or other power source or mover) data storage and utilization medium.

### Conclusion, Ramifications, and Scope

The reader should appreciate that the present invention provides for the introduction of a human element into the field of online banking. While the transactions described in discussing FIGS. 7 and 8 could be conducted using currently available online banking software, the interaction with a human being would be lost. This interaction was particularly valuable when the banker (42) suggested using a bank credit card to the customer (41). Such interaction and suggestions are simply not possible with currently available online banking software. Further, the present invention provided the bank representative (42) with a means to transfer the customer (41) to another bank representative (42) or bank officer (421) with more experience or authority with respect to the customer's issue. This option would not be available using currently available online banking software.

While the present invention is directed to online banking, it has conceivable applications in any other field queuing is contemplated and human interaction is desirable. As such, the present invention could be modified to accommodate, without limitation, doctor-patient interviews, retail sales (or any similar financial or business transaction), student-teacher encounters, employment interviews, performance evaluations, and the like.

### Associated Computer Program

As mentioned previously, the present invention is a customer online banking application (52). It is a system with specific features and a method with specific steps for conducting online banking transactions whereby an online customer (41), using a personal communication device (10), engages in live, two-way audio, video, and/or text communication with a human financial institution representative (42) who is using a bank communication device (30). The specific features and the specific steps inherent in the present invention are articulated in a machine readable computer program that identifies the command functions necessary to create the specific features and execute the specific steps to execute the online banking transaction(s) described herein.

We claim:

1. A computer-implemented method for conducting online banking using Internet communication devices and a human representative of a financial institution comprising the following steps:
a. a customer using a personal Internet communication device accessing said financial institution's online financial services computer program with said financial institution's online financial application installed therein,
b. said customer electronically requesting to interact online with said human representative of said financial institution,
c. said human representative accessing said financial institution's internal banking application using said financial institution's desktop or laptop computing device,
d. said accessing by said human representative electronically signaling availability to assist any said customer,
e. immediately placing said representative in a virtual agent repository to provide assistance to said customer,
f. immediately and electronically placing said customer into a virtual speaker's box where said customer has access to live two-way audio, video, and text communication capability with said human representative,
g. immediately and electronically matching said customer in said speaker's box with said human representative in said agent repository,
h. initiating said live two-way audio, video, and/or text communication to establish a live audio-video and/or text session between said customer and said human representative,
i. routing said live two-way audio, video, and/or text communication through an Internet web server back and forth between said customer and said human representative,
j. executing one or more online banking transactions while maintaining live two-way audio, video, and/or text communication between said customer and said human representative, and
k. terminating said live audio-video and/or text session between said customer and said human representative once said online transaction(s) has (have) been completed.

2. The method as recited in claim 1, wherein said personal Internet communication device is a personal computer.

3. The method as recited in claim 1, wherein said personal Internet communication device is a mobile communication device.

4. The method recited in claim 1 further comprising the steps of:
a. in the event that no said representative is available to assist a newly arriving customer or that other said customers are also waiting for assistance from any said representative, immediately placing said newly arrived customer in a virtual customer queue to await, in a virtual line determined by order of entry into said customer queue, for assistance from a next available said human representative, and
b. when any said next available human representative becomes available to assist said customer, immediately and electronically placing said customer into a virtual speaker's box where said customer has access to live two-way audio, video, and text communication capability with said next available human representative.

5. The method as recited in claim 4, wherein said personal Internet communication device is a personal computer.

6. The method as recited in claim 4, wherein said personal Internet communication device is a mobile communication device.

7. The method as recited in claim 1 further comprising one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

8. The method as recited in claim 7, wherein said personal Internet communication device is a personal computer.

9. The method as recited in claim 7, wherein said personal Internet communication device is a mobile communication device.

10. The method as recited in claim 4 further comprising one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

11. The method as recited in claim 10, wherein said personal Internet communication device is a personal computer.

12. The method as recited in claim 10, wherein said personal Internet communication device is a mobile communication device.

13. A system for conducting online banking using an Internet communication device and a human teller comprising:
a. a customer with a personal Internet communication device,
b. a human representative of a financial institution with a personal Internet communication device,
c. a server routing Internet communications back and forth between said customer and said human representation, and
d. said financial institution's online banking application, said online banking application having:
(1) a means for said customer using a said personal Internet communication device to access said financial institution's online financial services computer program with said financial institution's online financial application installed therein,
(2) a means for said customer to electronically request to interact online with said human representative of said financial institution,
(3) a means for said human representative to access said financial institution's internal banking application using said financial institution's desktop or laptop computing device,
(4) a means whereby said access by said human representative electronically signals availability to assist any said customer,
(5) a means for immediately placing said representative in a virtual agent repository to provide assistance to said customer,
(6) a means for immediately and electronically placing said customer into a virtual speaker's box where said customer has access to live two-way audio, video, and text communication capability with said human representative,
(7) a means for immediately and electronically matching said customer in said speaker's box with said human representative in said agent repository,
(8) a means for initiating said live two-way audio, video, and/or text communication to establish a live audio-video and/or text session between said customer and said human representative,
(9) a means for routing said live two-way audio, video, and/or text communication through an Internet web server back and forth between said customer and said human representative,
(10) a means for executing one or more online banking transactions while maintaining live two-way audio, video, and/or text communication between said customer and said human representative, and
(11) a means for terminating said live audio-video and/or text session between said customer and said human representative once said online transaction(s) has (have) been completed.

14. The method as recited in claim 13, wherein said personal Internet communication device is a personal computer.

15. The method as recited in claim 13, wherein said personal Internet communication device is a mobile communication device.

16. The system according to claim 13 further comprising:
(1) in the event that no said representative is available to assist a newly arriving customer or that other said customers are also waiting for assistance from any said representative, a means for immediately placing said newly arrived customer in a virtual customer queue to await, in a virtual line determined by order of entry into said customer queue, for assistance from a next available said human representative, and
(2). when any said next available human representative becomes available to assist said customer, a means for immediately and electronically placing said customer into a virtual speaker's box where said customer has access to live two-way audio, video, and text communication capability with said next available human representative.

17. The method as recited in claim 16, wherein said personal Internet communication device is a personal computer.

18. The method as recited in claim 16, wherein said personal Internet communication device is a mobile communication device.

19. The system according to claim 13 further comprising a means to accomplish one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

20. The method as recited in claim 19, wherein said personal Internet communication device is a personal computer.

21. The method as recited in claim 19, wherein said personal Internet communication device is a mobile communication device.

22. The system according to claim 16 further comprising a means for accomplishing one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

23. The method as recited in claim 22, wherein said personal Internet communication device is a personal computer.

24. The method as recited in claim 22, wherein said personal Internet communication device is a mobile communication device.

25. A computer-implemented method for conducting online banking using wearable Internet communication devices and a human representative of a financial institution comprising the following steps:
a. a customer using a wearable Internet communication device accessing said financial institution's online financial services computer program with said financial institution's online financial application installed therein,
b. said customer electronically requesting to interact online with said human representative of said financial institution,
c. said human representative accessing said financial institution's internal banking application using said financial institution's desktop or laptop computing device,
d. said accessing by said human representative electronically signaling availability to assist any said customer,
e. immediately placing said representative in a virtual agent repository to provide assistance to said customer,
f. immediately and electronically placing said customer into a virtual speaker's box where said customer has access to live two-way audio and video communication capability with said human representative,
g. immediately and electronically matching said customer in said speaker's box with said human representative in said agent repository,
h. initiating said live two-way audio and video communication to establish a live audio-video session between said customer and said human representative,
i. routing said live two-way audio and video communication through an Internet web server back and forth between said customer and said human representative,
j. executing one or more online banking transactions while maintaining live two-way audio and video communication between said customer and said human representative, and
k. terminating said live audio-video session between said customer and said human representative once said online transaction(s) has (have) been completed.

26. The method recited in claim 26 further comprising the steps of:
a. in the event that no said representative is available to assist a newly arriving customer or that other said customers are also waiting for assistance from any said representative, immediately placing said newly arrived customer in a virtual customer queue to await, in a virtual line determined by order of entry into said customer queue, for assistance from a next available said human representative, and
b. when any said next available human representative becomes available to assist said customer, immediately and electronically placing said customer into a virtual speaker's box where said customer has access to live two-way audio, video, and text communication capability with said next available human representative.

27. The method as recited in claim 25 further comprising one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

28. The method as recited in claim 26 further comprising one or more of the following steps:
a. said human representative transferring said customer to a second human representative or bank officer in the event said human representative is unable to properly assist said customer,
b. said customer executing an exit from said live two-way audio, video, and/or text session,
c. said human representative terminating said live two-way audio, video, and/or text session in the event said customer fails to explicitly exit,
d. said customer sending a file or image to said human representative,
e. said human representative sending a file or image to said customer,
f. said human representative viewing personal and/or account information pertaining to said customer on a screen on said financial institution's desktop or laptop computing device used by said human representative,
g. said human representative viewing an image of said customer on a screen on said financial institution's desktop or laptop computing device used by said human representative,
h. said customer viewing an image of human representative on a screen on said customer's said personal Internet computing device,
i. said customer and said human representative exchanging text messages with one another, and
j. said customer and said human representative conversing with one another.

29. A computer program comprising machine readable language articulating the functions necessary to execute the steps identified in claim 1.

30. The computer program as recited in claim 29 further comprising machine readable language articulating the functions necessary to execute the steps identified in claim 4.

31. The computer program as recited in claim 29 further comprising machine readable language articulating the functions necessary to execute the steps identified in claim 7.

32. The computer program as recited in claim 30 further comprising machine readable language articulating the functions necessary to execute the steps identified in claim 10.

33. A computer program comprising machine readable language articulating the functions necessary to execute the steps identified in claim 13.

34. The computer program as recited in claim 33 further comprising machine readable language articulating the functions necessary to execute the steps identified in claim 16.

35. The computer program as recited in claim 33 further comprising machine readable language articulating the functions necessary to execute the steps identified in claim 19.

36. The computer program as recited in claim 34 further comprising machine readable language articulating the functions necessary to execute the steps identified in claim 22.

37. A computer program comprising machine readable language articulating the functions necessary to execute the steps identified in claim 25.

38. The computer program as recited in claim 37 further comprising machine readable language articulating the functions necessary to execute the steps identified in claim 26.

39. The computer program as recited in claim 37 further comprising machine readable language articulating the functions necessary to execute the steps identified in claim 27.

40. The computer program as recited in claim 26 further comprising machine readable language articulating the functions necessary to execute the steps identified in claim 28.
